(19) United States
(12) Patent Application Publication
(10) Pub. No.: US 2011/0267194 A1
(43) Pub. Date: Nov. 3, 2011

(54) COMPACT DIRECTIONAL COUPLER USING SEMICONDUCTOR PROCESS AND MOBILE RFID READER TRANSCEIVER SYSTEM USING THE SAME

(76) Inventors: Song Cheol Hong, Daejon (KR); Sun Bo Shim, Busan (KR)

(21) Appl. No.: 12/831,240

(22) Filed: Jul. 6, 2010

(30) Foreign Application Priority Data
May 3, 2010 (KR) 10-2010-0041269

(51) Int. Cl. H01P 5/18; G08B 13/14

(52) U.S. Cl. 340/572.7; 333/109

(57) ABSTRACT

A compact directional coupler and a mobile Radio-Frequency Identification (RFID) reader transceiver system using the same. The compact directional coupler can include a primary transmission line, a secondary transmission line, and a second capacitor connected in parallel to the secondary transmission line. The coupler can further include a first capacitor connected in parallel to the primary transmission line and capacitors connected between both end of the first capacitors and the ground respectively. A mobile RFID reader transceiver system can include a transmission terminal circuit, a power amplifier, the compact directional coupler, an antenna, a low noise amplifier, and the reception terminal circuit. The system further can include a band-pass filer, and/or a power combiner to match an output terminal of the power amplifier.

### CROSS-REFERENCE TO RELATED APPLICATIONS

The present application claims priority under 35 U.S.C. 119 of Korean Patent Application No. 10-2010-0041269, filed on May 3, 2010, the disclosure of which is expressly incorporated by reference herein in its entirety.

### BACKGROUND OF THE INVENTION

1. Field of the Invention

The present invention relates generally to a directional coupler and a mobile Radio-Frequency Identification (RFID) reader transceiver system using the same, and, more particularly, to a compact directional coupler using a semiconductor process and a mobile RFID reader transceiver system using the same.

2. Description of the Related Art

RFID is a system which receives and decodes a signal and then detects the information of a corresponding tag when a wireless signal is transmitted from a reader and reaches a tag, and the wireless signal is modulated and returns to the reader. Fixed RFID readers have been widely used in logistics, traffic and distribution. Such a reader including a directional antenna is fixed at a predetermined place, and the reader obtains the information of a tag when the tag passes by a location falling within the distance recognizable by the reader.

Meanwhile, mobile RFID is portable since the functions of such a RFID reader are built in a small-sized, integrated terminal.

Due to the spatial limits of the inside of such an integrated terminal, mobile RFID readers have been realized in the form of an integrated single chip in many cases, and generally, have processed transmission/reception signals by sharing a single antenna. In many cases, conventional RFID systems are provided with a circulator mounted on the front end of an antenna so that transmission and reception terminals can share the antenna, thereby distributing signals with directivity.

However, circulators have the disadvantages of being large, the isolation between ports being deteriorated, and being high-priced, so that the circulators are not suitable for mobile RFID systems which are required to be applied to small-sized terminals.

### SUMMARY OF THE INVENTION

Accordingly, the present invention has been made keeping in mind the above problems occurring in the prior art, and an object of the present invention is to provide a mobile RFID reader transceiver system, the size and production cost of which can be reduced by producing a directional coupler using an integrated semiconductor process instead of a circulator.

Another object of the present invention is to reduce the size of the directional coupler and increase the coupling coefficient by forming a primary transmission line and a secondary transmission line in a spiral arrangement and by forming capacitors to be parallel to the respective transmission lines.

In order to accomplish the above object, the present invention provides a compact directional coupler using a semiconductor process, including: a primary transmission line formed on a semiconductor substrate; a secondary transmission line formed on the semiconductor substrate; and a second capacitor connected in parallel to the secondary transmission line.

In more detail, the primary transmission line and the secondary transmission line can be formed in a spiral arrangement using the metal line process of the semiconductor process. That is, the primary transmission line and the secondary transmission line can be formed in the spiral arrangement in such a way that the primary transmission line surrounds the outside of the secondary transmission line, and the secondary transmission line surrounds the inside of the primary transmission line.

Further, the ratio of the number of turns of the primary transmission line to that of the secondary transmission line in the spiral arrangement can be arbitrarily determined, and a multi-layer metal line process can be used in order to increase the number of turns of the primary transmission line and the secondary transmission line in the spiral arrangement.

Further, a first capacitor connected in parallel to the primary transmission line also can be included, and the capacitance of the first capacitor can be less than that of the second capacitor. Further, a third capacitor can be arranged between one of the two ports of the primary transmission line and the ground, and a fourth capacitor may be arranged between the remaining port of the two ports of the primary transmission line and the ground.

The compact directional coupler can further include a resistor between one of the two ports of the secondary transmission line and the ground, and the resistor has a resistance of 50 Ω.

In more detail, the semiconductor process can be an integrated passive device process.

In order to accomplish the above objects, the present invention provides a mobile Radio-Frequency Identification (RFID) reader transceiver system including: a transmission terminal circuit for processing a transmission signal; a power amplifier for amplifying the transmission signal; a directional coupler for connecting a transmission/reception antenna to the transmission terminal circuit and a reception terminal circuit, the transmission/reception antenna for transmitting and receiving a signal; a low noise amplifier for amplifying a signal while maintaining a high signal-to-noise ratio of a reception signal; and the reception terminal circuit for processing the reception signal.

Further, the mobile RFID reader transceiver system also can include a band-pass filter between the directional coupler and the low noise amplifier, and the band-pass filter is a Surface Acoustic Wave (SAW) filter, a Bulk Acoustic Filter (BAW), or a ceramic filter.

In more detail, the mobile RFID reader transceiver system can further include a power combiner arranged between the directional coupler and the power amplifier, and configured to match the output terminal of the power amplifier, and the directional coupler and the power combiner are produced in a single chip using a semiconductor process.

Further, the semiconductor process can be an integrated passive device process.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a conventional RFID reader in which an antenna is connected with transmission and reception terminals using a circulator;

FIG. 2 is a diagram showing a general directional coupler implemented using two lines coupled with each other in a parallel structure;

FIG. 3 is a circuit diagram showing a compact directional coupler according to a first embodiment of the present invention;

FIG. 4 is a view showing the layout of the circuit diagram of FIG. 3;

FIG. 5 is a circuit diagram showing a compact directional coupler according to a second embodiment of the present invention, and FIG. 6 is a view showing the layout of the circuit diagram of FIG. 5;

FIG. 7 is a circuit diagram showing a compact directional coupler according to a third embodiment of the present invention, and FIG. 8 is a view showing the layout of the circuit diagram of FIG. 7;

FIGS. 9 and 10 are views showing other layouts of the circuit diagram of FIG. 5;

FIG. 11 is a circuit diagram showing a compact directional coupler according to a fourth embodiment of the present invention;

FIG. 12 is a view showing a mobile RFID reader transceiver system according to an embodiment of the present invention;

FIG. 13 is a view showing a mobile RFID reader transceiver system which further includes a band-pass filter according to an embodiment of the present invention;

FIG. 14 is a view showing a mobile RFID reader transceiver system which further includes a power combiner according to an embodiment of the present invention; and

FIGS. 15 and 16 are views showing layouts in which a power combiner and a directional coupler are integrated into a single chip according to an embodiment of the present invention.

### DESCRIPTION OF THE PREFERRED EMBODIMENTS

Reference now should be made to the drawings, in which the same reference numerals are used throughout the different drawings to designate the same or similar components.

Hereinafter, a compact directional coupler using a semiconductor process and a mobile RFID reader transceiver system using the same according to an embodiment of the present invention will be described in detail with reference to the attached drawings.

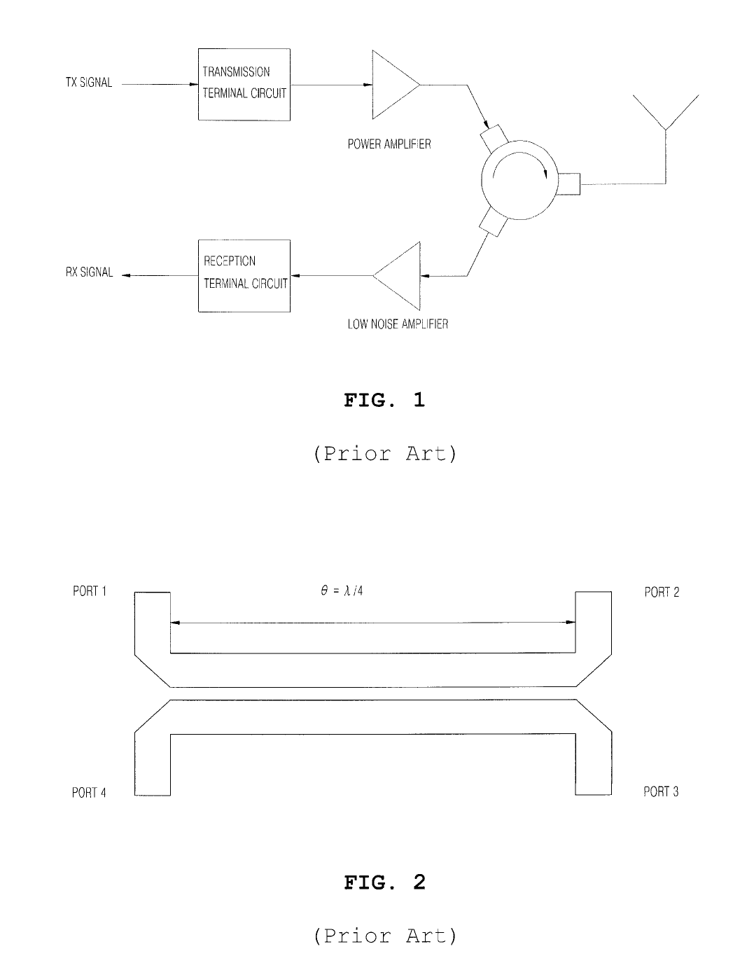

FIG. 1 is a diagram showing a conventional RFID reader in which an antenna is connected with transmission and reception terminals using a circulator.

However, circulators have the disadvantages of being too large to fit in a small-sized terminal, the isolation between ports being deteriorated, and their price being high, so that circulators are not suitable for mobile RFID systems.

If a directional coupler is used instead of such a circulator, the cost can be reduced and the isolation between ports can be improved.

Generally, the directional coupler can be implemented using two lines coupled with each other in a parallel structure as shown in FIG. 2, and the length corresponds to an electrical length of λ/4. If such a directional coupler is implemented on a Printed Circuit Board (PCB) in the form of a microstrip line, the size of it is considerably large, so that the directional coupler is not suitable for application to mobile RFID reader systems. Even if the directional coupler is implemented using ceramic or other package methods, the size of it is still large, and high production costs will be imposed.

Therefore, the present invention proposes a directional coupler using a semiconductor process, in which size and cost can be reduced, and a mobile RFID reader transceiver system using the same.

In particular, if the Integrated Passive Device (IPD) process of the semiconductor process is used, in which only passive elements are integrated so that their performance is maximized, the size and cost of the directional coupler can be effectively reduced.

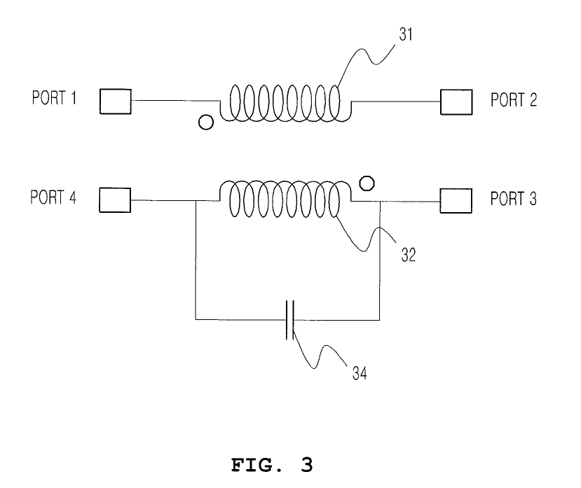

FIG. 3 is a circuit diagram showing a compact directional coupler according to a first embodiment of the present invention.

As shown in FIG. 3, the compact directional coupler of the present invention includes a primary transmission line 31, a secondary transmission line 32, and a second capacitor 34 which is connected in parallel with the secondary transmission line 32.

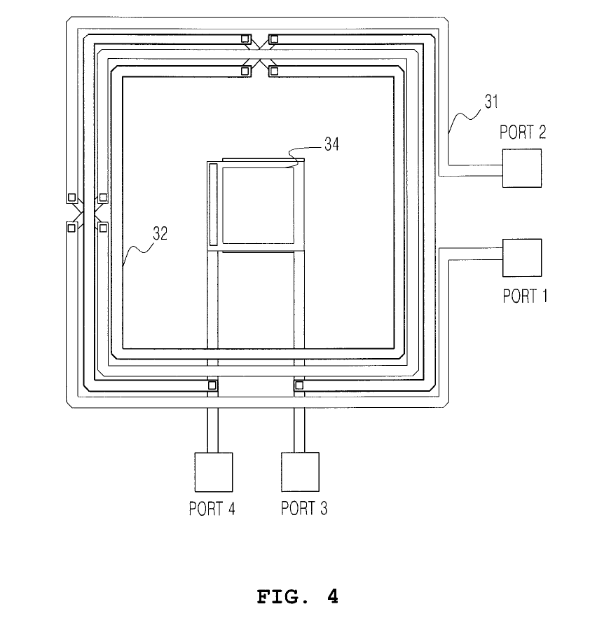

FIG. 4 is a view showing the layout of the circuit diagram of FIG. 3.

The elements of the compact directional coupler of the present invention will be described in detail with reference to FIGS. 3 and 4.

The primary transmission line 31 can be formed so that a signal is transmitted therethrough, and the secondary transmission line 32 can be formed as a transmission line for coupling in such a way that the secondary transmission line 32 is adjacent to the primary transmission line 31 so as to extract some of the power of the signal transmitted through the primary transmission line 31. Further, the primary transmission line 31 and the secondary transmission line 32 can be formed on a semiconductor substrate. An insulating layer can be interposed between the semiconductor substrate and the primary and secondary transmission lines 31 and 32.

The primary transmission line 31 and the secondary transmission line 32 can be formed using the metal line process of the semiconductor process, and formed in a spiral arrangement in order to minimize their size and length, and to improve the coupling coefficient.

That is, the number of times that metal lines are bent can be minimized using a transmission-line transformer having a spiral structure. Further, since the total length of the metal line is far shorter than the length of a general directional coupler (λ/4), insertion loss, generated during the transmission of a desired signal through the metal line, can be minimized.

The primary transmission line 31 and the secondary transmission line 32 are arranged in parallel with each other, are overlapped with each other in a spiral form, and are adjacent to each other. A second capacitor 34 can be connected to the secondary transmission line 32, in parallel between the two ports of the secondary transmission line 32.

That is, as shown in the layout of the view of FIG. 4, the primary transmission line 31 surrounds the outside of the secondary transmission line 32 and the secondary transmission line 32 surrounds the inside of the primary transmission line 31 as an example of the overlapped arrangement in the spiral form of the present invention. Further, the ratio of the number of turns of the primary transmission line 31 to that of the secondary transmission line 32 in a spiral arrangement can be arbitrarily determined.

In more detail, as shown in FIG. 4, the ratio of the number of turns of the primary transmission line 31 to that of the secondary transmission line 32 of the transmission line transformer in a spiral arrangement can be 2:2. That is, when the primary transmission line 31 and the secondary transmission line 32 are separated and then viewed, they both make two turns in a spiral arrangement. The ratio of the number of turns of the primary transmission line 31 to that of the secondary transmission line 32 of the transmission line transformer in the spiral arrangement can be 1:1, or N:N (a plural number).

Further, in order to increase the number of turns of the primary transmission line 31 and the secondary transmission line 32 in the spiral arrangement, a multi-layer metal line process can be used.

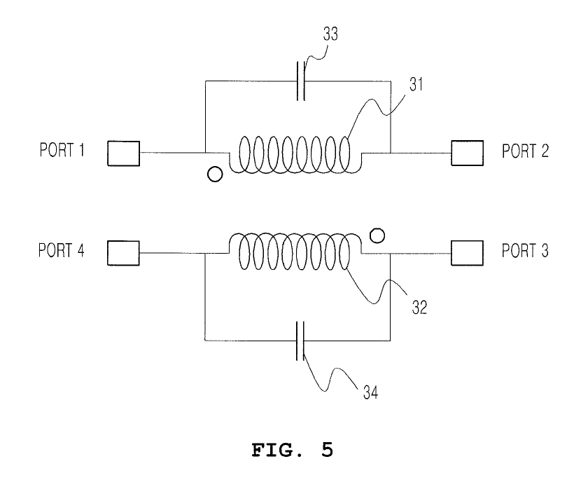

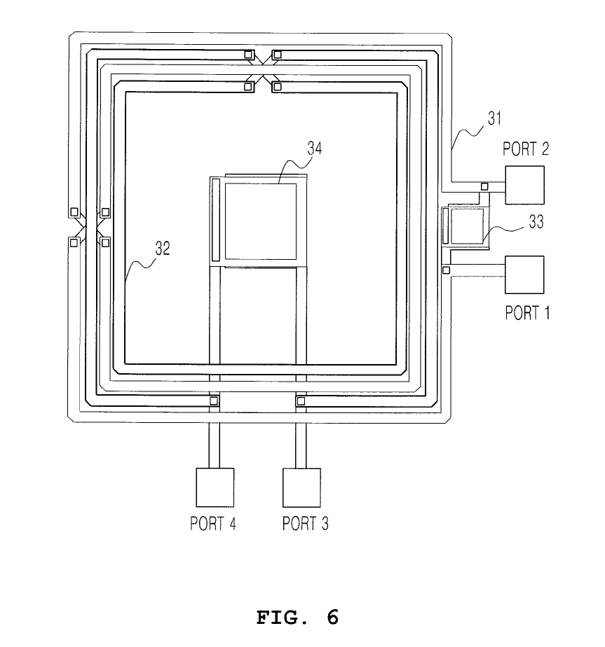

FIG. 5 is a circuit diagram showing a compact directional coupler according to a second embodiment of the present invention, and FIG. 6 is a view showing the layout of the circuit diagram of FIG. 5.

That is, as compared with FIGS. 3 and 4, FIGS. 5 and 6 show that the compact directional coupler also can include a first capacitor 33 connected in parallel with the primary transmission line 31. Further, the capacitance of the first capacitor 33 is less than that of the second capacitor 34.

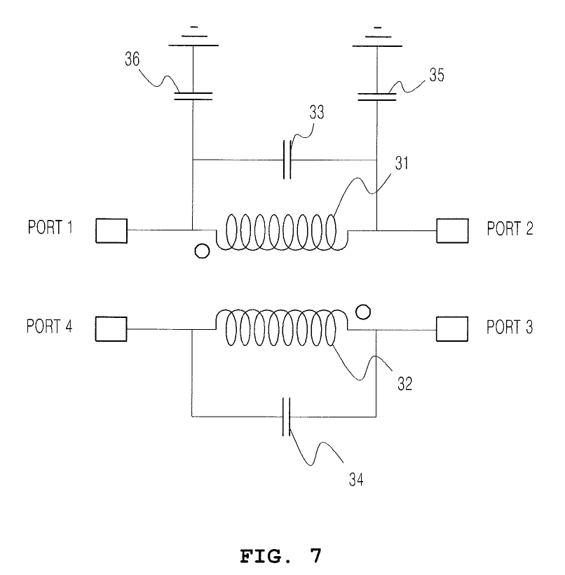

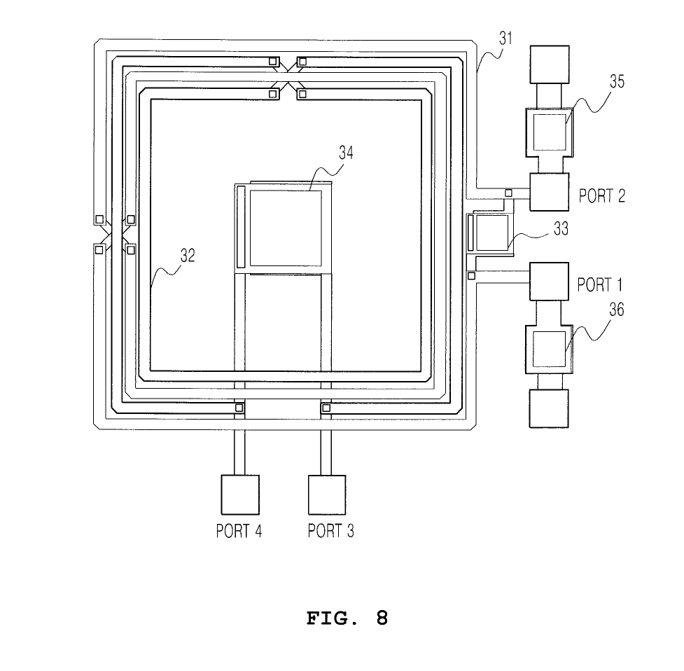

FIG. 7 is a circuit diagram showing a compact directional coupler according to a third embodiment of the present invention, and FIG. 8 is a view showing the layout of the circuit diagram of FIG. 7.

That is, for the purpose of impedance matching, the compact directional coupler also can include a third capacitor 35, arranged between the one port of the primary transmission line 31 and the ground, and a fourth capacitor 36, arranged between the remaining port of the primary transmission line 31 and the ground.

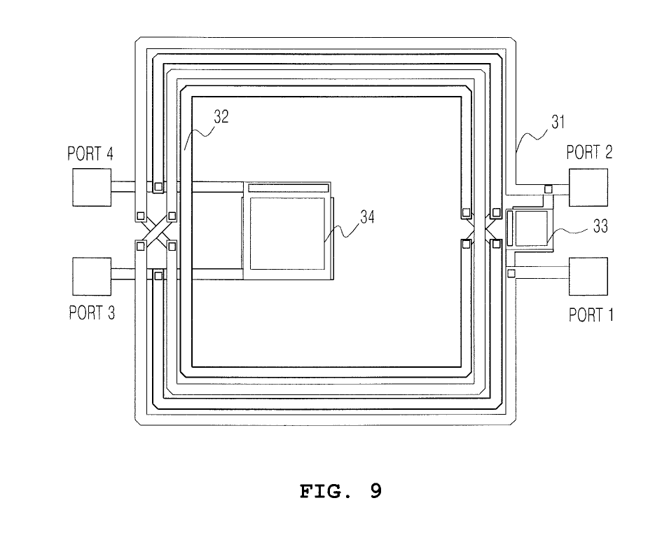

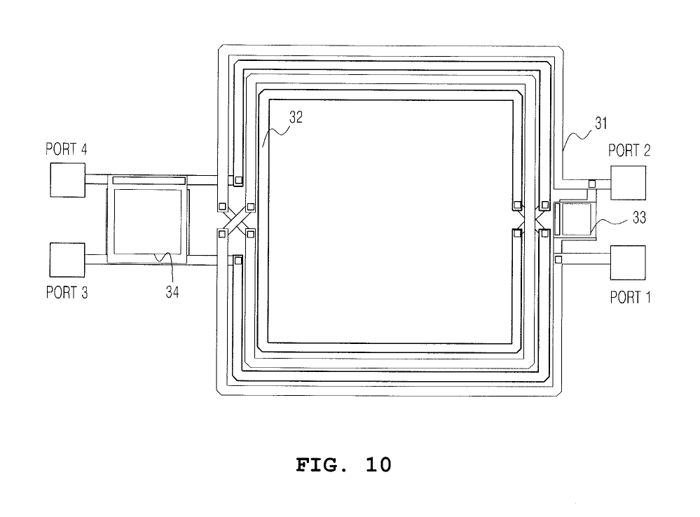

FIGS. 9 and 10 are views showing the examples of various layouts of the circuit diagram according to the second embodiment of FIG. 5.

That is, FIG. 9 shows two ports of the secondary transmission line 32 which are arranged to face the two ports of the primary transmission line 31. Unlike FIG. 9, in which the second capacitor 34 connected between the two ports of the secondary transmission line 32 is arranged inside of the transmission line transformer, FIG. 10 is a view showing the layout in which the second capacitor 34 is arranged outside of the transmission line transformer. The change of the layout of each of the elements can be applied to the circuit diagrams of FIGS. 5 and 7 in the same way.

In the case of a general inductor having a spiral structure, very large insertion loss can be generated along the transmission path. Therefore, the present invention additionally uses a transmission line transformer structure in the form of various lateral couplers (couplers in which signals are magnetically coupled on the side surface of a line), such as the first capacitor 33, the second capacitor 34, the third capacitor 35, and the fourth capacitor 36, so that the structure is simplified, thereby reducing the entire size and minimizing insertion loss.

The capacitors, such as the first capacitor 33, the second capacitor 34, the third capacitor 35, and the fourth capacitor 36, can be implemented using, for example, a Metal Insulator Metal (MIM) capacitor or a diffusion capacitor in the semiconductor process.

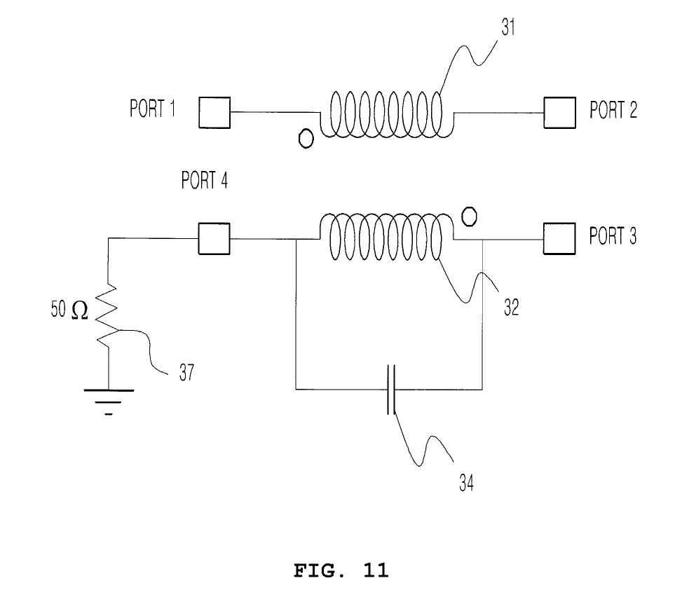

FIG. 11 is a circuit diagram showing a compact directional coupler which further includes a resistor 37, according to a fourth embodiment of the present invention.

That is, one of the two ports of the secondary transmission line 32 can transfer power extracted from the primary transmission line 31, and a resistor can be further included between the remaining port of the secondary transmission line 32 and the ground.

In more detail, as shown in FIG. 11, if a termination resistor of 50 Ω is connected to one of the four ports of the directional coupler and the remaining three ports are respectively connected to an antenna, a transmission terminal and a reception terminal, a function similar to that of a RFID system on which a circulator is mounted is shown.

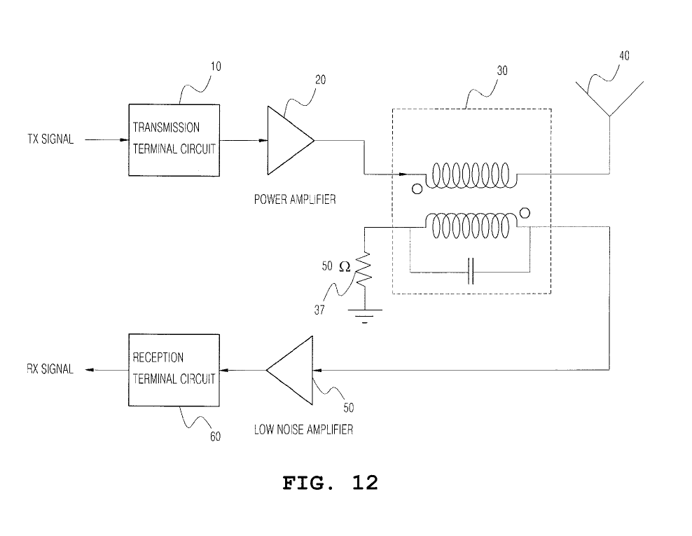

FIG. 12 is a view showing a mobile RFID reader transceiver system using the compact directional coupler according to a preferable embodiment.

As shown in FIG. 12, the mobile RFID reader transceiver system according to the preferable embodiment can include a transmission terminal circuit 10 for processing a transmission signal, a power amplifier 20 for amplifying the transmission signal, a directional coupler 30 for connecting a transmission/reception antenna to the transmission terminal circuit and the reception terminal circuit, the transmission/reception antenna 40 for transmitting and receiving a signal, a low noise amplifier 50 for amplifying a signal while maintaining the high signal-to-noise ratio of a reception signal, and the reception terminal circuit 60 for processing the reception signal.

Further, the resistor 37, arranged between one of the two ports of the secondary transmission line 32 and the ground, can be arranged inside or outside of the directional coupler 30.

A differential amplifier circuit can be used as an example for the power amplifier 20 and the low noise amplifier 50.

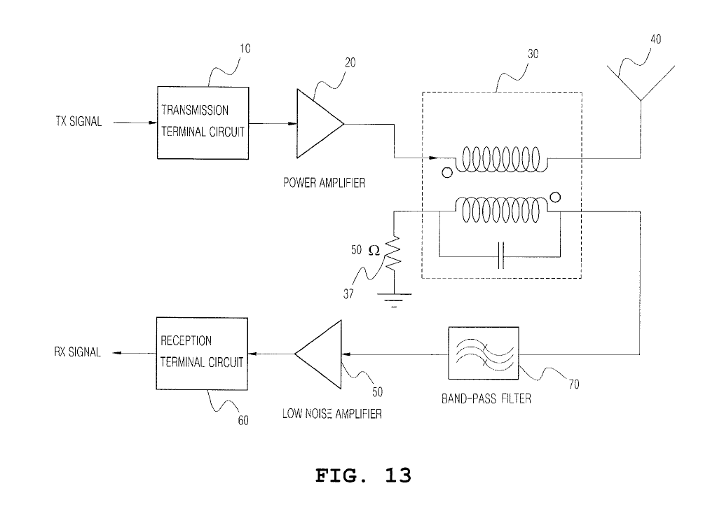

As shown in FIG. 13, the mobile RFID reader transceiver system of the present invention also can include a band-pass filter 70 between the directional coupler 30 and the low noise amplifier 50, the band-pass filter 70 having excellent filtering characteristics for removing signals which exist in bands other than an Ultra High Frequency (UHF) RFID band from the reception path.

Further, the band-pass filter 70 can be a Surface Acoustic Wave (SAW) filter, a Bulk Acoustic Filter (BAW), or a ceramic filter.

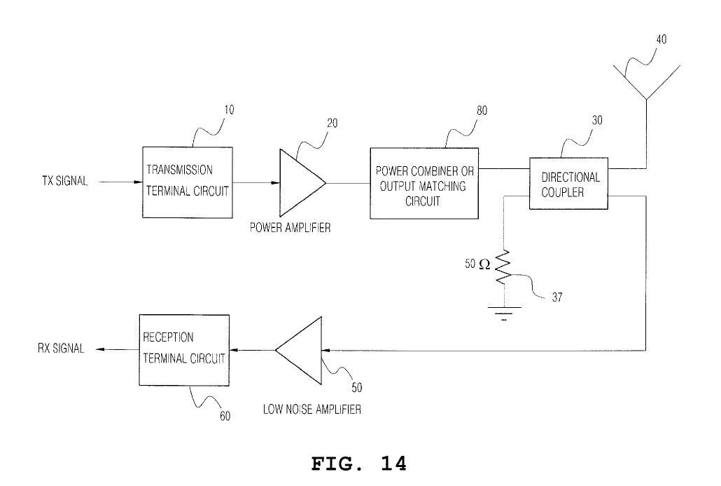

FIG. 14 is a view showing a mobile RFID reader transceiver system, which further includes a power combiner 80 arranged between the directional coupler 30 and the power amplifier 20, and configured to match the output terminal of the power amplifier 20, according to an embodiment of the present invention.

Further, the power combiner 80 and the directional coupler 30 can be produced in the form of a single chip using the semiconductor process. In particular, an Integrated Passive Device (IPD) process can be used as the semiconductor process.

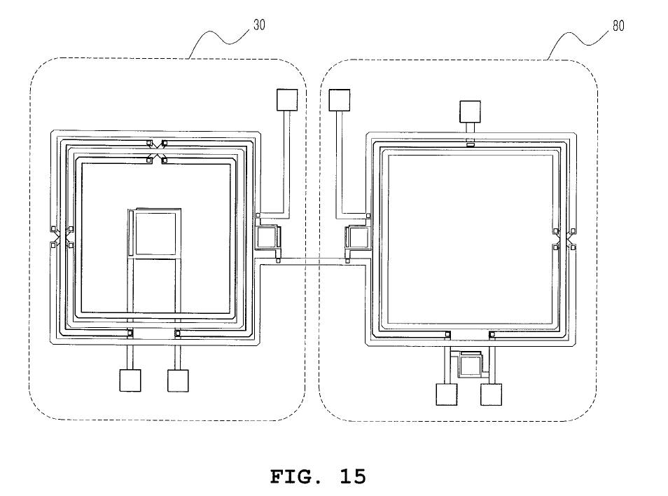

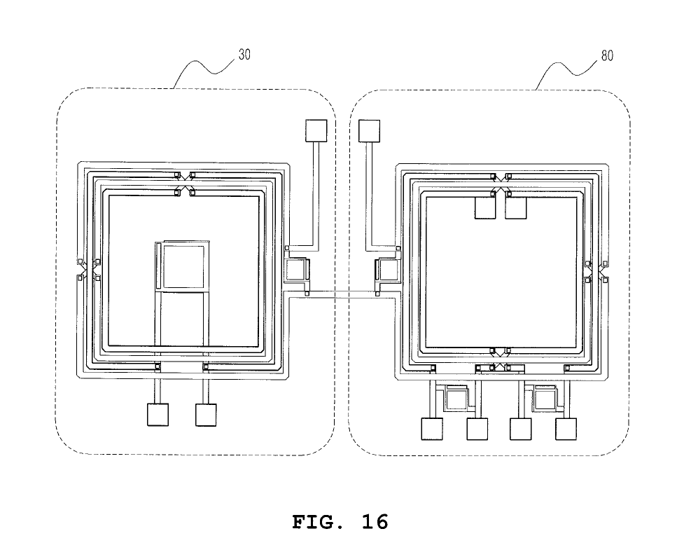

FIGS. 15 and 16 are views showing layouts in which the power combiner 80 and the directional coupler 30 are integrated into a single chip.

FIG. 15 shows an example in which the power combiner 80 for a pair of differential power amplifier circuits is connected to the directional coupler 30, and FIG. 16 shows an example in which the power combiner 80 for two pairs of differential amplifier circuits is connected to the directional coupler 30. The directional couplers 30 of FIGS. 15 and 16 are shown using the view of the layout of FIG. 6.

The advantages of the above-described present invention will be described in detail below.

First, there is an advantage in that the directional coupler can be compact. The directional coupler 30 of the present invention can be produced using a semiconductor process, and has a far smaller size than that of a general directional coupler implemented on a PCB. In particular, since the directional coupler has a transmission line transformer having a spiral structure, a higher magnetic coupling coefficient can be obtained using a length that is shorter than that of the directional coupler having a parallel two line structure. Further, the directional coupler can have a form which approximates a square, which is beneficial from the viewpoint of integration.

Second, insertion loss can be minimized. That is, the number of times that metal lines are bent can be minimized in a method using a transmission line transformer having a spiral structure in lieu of the method using a plurality of inductors, each having a spiral structure. Since the total length of the metal line is far shorter than the length (λ/4) of a general directional coupler, insertion loss, generated during the transmission of a desired signal through the metal line, may be minimized.

Third, the directional coupler of the present invention has a compact size and satisfies the conditions of isolation and coupling which are required by the mobile RFID reader.

Fourth, the directional coupler of the present invention is integrated with the power combiner 80 for matching the output terminal of the power amplifier 20, so that integration is maximized and the characteristics of the power amplifier 20 can be compensated for. That is, the first capacitor 33, arranged in parallel with the primary transmission line 31, functions to improve the isolation of the directional coupler 30 and also functions as a notch filter for removing specific frequency components. That is, integrating the directional coupler 30 of the present invention with the power combiner 80 can be helpful for removing the harmonic components unavoidably generated by the output of the power amplifier 20.

Fifth, the production cost can be reduced. Since production is performed using an integrated process, mass production can be easily implemented, the size of the directional coupler can be kept small, and production can be performed using a generally and widely used silicon integrated circuit process. Further, as described in the fourth advantage above, if the directional coupler 30 of the present invention is integrated with other components, reduction of production costs can be maximized.

Sixth, if the directional coupler 30 of the present invention is integrated with the power amplifier 20, the present invention can be utilized as a part of the transmission power control system of a mobile communication terminal, such as a mobile phone, as well as for a RFID reader system. The transmission power is controlled in a closed-loop manner using the directional coupler in such a way that the output signal of a current amplifier is detected, the detected output signal is rectified into DC current through a diode, and the resulting current is compared with a reference voltage using a comparator. The considerable parts of the devices can be integrated in a compact size.

According to the compact directional coupler using a semiconductor process of the present invention, the directional coupler is manufactured using an integrated semiconductor process and is used instead of a circulator, in a mobile RFID reader transceiver system, the size and production cost of which can be reduced.

Further, the primary transmission line and the secondary transmission line are formed in the spiral arrangement, and capacitors are formed to be adjacent to the respective transmission lines in parallel, so that the size of the directional coupler can be reduced and the coupling coefficient can be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-22. (canceled)

23. A compact directional coupler using a semiconductor process, the compact directional coupler comprising:
a primary transmission line formed on a semiconductor substrate;
a secondary transmission line formed on the semiconductor substrate; and
a capacitor connected in parallel to the secondary transmission line.

24. The compact directional coupler as set forth in claim 23, wherein the primary transmission line and the secondary transmission line are formed in a spiral arrangement using a metal line process of the semiconductor process.

25. The compact directional coupler as set forth in claim 24, wherein an outside loop of the primary transmission line surrounds the secondary transmission line, and an outside loop of the secondary transmission line surrounds an inside loop of the primary transmission line.

26. The compact directional coupler as set forth in claim 24, wherein a ratio of a number of turns of the primary transmission line to that of the secondary transmission line in the spiral arrangement is arbitrarily determined.

27. The compact directional coupler as set forth in claim 24, wherein the metal line process is a multi-layer metal line process configured to increase a number of turns of the primary transmission line and the secondary transmission line in the spiral arrangement.

28. The compact directional coupler as set forth in claim 23, further comprising a capacitor connected in parallel to the primary transmission line.

29. The compact directional coupler as set forth in claim 28, wherein capacitance of the capacitor that is connected in parallel to the primary transmission line is less than that of the capacitor that is connected in parallel to the secondary transmission line.

30. The compact directional coupler as set forth in claim 28, further comprising:
a capacitor arranged between one port of the primary transmission line and the ground; and
a capacitor arranged between another port of the primary transmission line and the ground.

31. The compact directional coupler as set forth in claim 23, further comprising a resistor arranged between one port of the secondary transmission line and the ground.

32. The compact directional coupler as set forth in claim 31, wherein the resistor has a resistance of 50 Ω.

33. The compact directional coupler as set forth in claim 23, wherein the semiconductor process is an integrated passive device process.

34. A mobile Radio-Frequency Identification (RFID) reader transceiver system comprising:
a transmission terminal circuit configured to process a transmission signal;
a power amplifier configured to amplify the transmission signal;
a transmission/reception antenna configured to transmit the transmission signal and receive a reception signal;
a low noise amplifier configured to amplify the reception signal;
a reception terminal circuit configured to process the reception signal; and
a directional coupler configured to connect the transmission/reception antenna to the power amplifier and the low noise amplifier;
wherein the directional coupler comprises:
a primary transmission line formed on a semiconductor substrate;
a secondary transmission line formed on the semiconductor substrate; and
a capacitor connected in parallel to the secondary transmission line.

35. The mobile RFID reader transceiver system as set forth in claim 34, wherein the primary transmission line and the secondary transmission line are formed in a spiral arrangement using a metal line process of a semiconductor process, an outside loop of the primary transmission line surrounds the secondary transmission line, and an outside loop of the secondary transmission line surrounds an inside loop of the primary transmission line.

36. The mobile RFID reader transceiver system as set forth in claim 34, further comprising a resistor arranged between one of two ports of the secondary transmission line and the ground.

37. The mobile RFID reader transceiver system as set forth in claim 34, further comprising a capacitor connected in parallel to the primary transmission line.

38. The mobile RFID reader transceiver system as set forth in claim 37, further comprising:
a capacitor arranged between one port of the primary transmission line and the ground; and
a capacitor arranged between another port of the primary transmission line and the ground.

39. The mobile RFID reader transceiver system as set forth in claim 34, further comprising a band-pass filter arranged between the directional coupler and the low noise amplifier.

40. The mobile RFID reader transceiver system as set forth in claim 39, wherein the band-pass filter is one of a Surface Acoustic Wave (SAW) filter, a Bulk Acoustic Filter (BAW), or a ceramic filter.

41. The mobile RFID reader transceiver system as set forth in claim 34, further comprising a power combiner arranged between the directional coupler and the power amplifier, and configured to match an output terminal of the power amplifier.

42. The mobile RFID reader transceiver system as set forth in claim 41, wherein the directional coupler and the power combiner are packaged in a single chip using a semiconductor process.

43. The mobile RFID reader transceiver system as set forth in claim 42, wherein the semiconductor process is an integrated passive device process.

44. The compact directional coupler as set forth in claim 29, further comprising:
a capacitor arranged between one port of the primary transmission line and the ground; and
a capacitor arranged between another port of the primary transmission line and the ground.

45. A compact directional coupler comprising:
a primary transmission line having a value of inductance, wherein a signal is transmitted thorough the primary transmission line;
a secondary transmission line having a value of inductance, the secondary transmission line extracting a portion of the power of the signal transmitted through the primary transmission line; and
a capacitor connected in parallel to the secondary transmission line.

46. The compact directional coupler as set forth in claim 45, further comprising a capacitor connected in parallel to the primary transmission line.

47. The compact directional coupler as set forth in claim 46, wherein the capacitance of the capacitor that is connected in parallel to the primary transmission line is less than the capacitance of the capacitor that is connected in parallel to the secondary transmission line.

48. The compact directional coupler as set forth in claim 46, further comprising:
a capacitor connected between one port of the primary transmission line and the ground; and
a capacitor connected between another port of the primary transmission line and the ground.

49. The compact directional coupler as set forth in claim 45, further comprising a resistor connected between one port of the secondary transmission line and the ground.

50. The compact directional coupler as set forth in claim 49, wherein the resistor has a resistance of 50 Ω.

51. A mobile Radio-Frequency Identification (RFID) reader transceiver system comprising:
a transmission terminal circuit configured to process a transmission signal;
a power amplifier configured to amplify the transmission signal;
a power combiner configured to match an output terminal of the power amplifier;
a transmission/reception antenna configured to transmit the transmission signal and receive a reception signal;
a low noise amplifier configured to amplify the reception signal while maintaining a high signal-to-noise ratio of the reception signal;
a reception terminal circuit configured to process the reception signal; and
a directional coupler configured to connect the transmission/reception antenna to the power combiner and the low noise amplifier;
wherein the directional coupler comprises:
a primary transmission line formed on a semiconductor substrate;
a secondary transmission line formed on the semiconductor substrate;
a capacitor connected in parallel to the primary transmission line;
a capacitor connected in parallel to the secondary transmission line;
a capacitor arranged between one port of the primary transmission line and the ground;
a capacitor arranged between another port of the primary transmission line and the ground; and
a resistor arranged between one of two ports of the secondary transmission line and the ground,
wherein the primary transmission line and the secondary transmission line are formed in a spiral arrangement using a metal line process of a semiconductor process, an outside loop of the primary transmission line surrounds the secondary transmission line, and an outside loop of the secondary transmission line surrounds an inside loop of the primary transmission line,
wherein the directional coupler and the power combiner are packaged in a single chip using a semiconductor process, and
wherein the semiconductor process is an integrated passive device process.
